(19) United States
(12) Patent Application Publication
(10) Pub. No.: US 2006/0248654 A1
(43) Pub. Date: Nov. 9, 2006

(54) Process for treating animal skins

(76) Inventors: Hermanus Johannus Berkhout, Apeldoom (NL); Jose Ramon Garcia Del Rio, Esplugas de Llobregat (ES)

Correspondence Address: OLIFF & BERRIDGE, PLC, P.O. BOX 19928, ALEXANDRIA, VA, 22320, US

(21) Appl. No.: 10/569,608

(22) PCT Filed: Dec. 9, 2004
(86) PCT No.: PCT/EP04/14155

§ 371 Date: Apr. 20, 2006

Related U.S. Application Data
(60) Provisional application No. 60/548,174, filed on Mar. 1, 2004.

(30) Foreign Application Priority Data
Dec. 17, 2003 (EP) 03078900.2

(51) Int. Cl. C14C 1/00

(52) U.S. Cl. 8/94.15

(57) ABSTRACT

The present invention pertains to a process for decreasing and/or drying skins which comprises contacting the skins to be degreased and/or dried with one or more extractor solvents which are able to dissolve both fat and water. Preferably, the extractor solvent is selected from the group consisting of dimethyl ether (DME), methylal, dioxolane, diethyl ether, methyl ethyl ketone, ethanol, propanol, and isopropanol. Most preferably, the extractor solvent is DME.

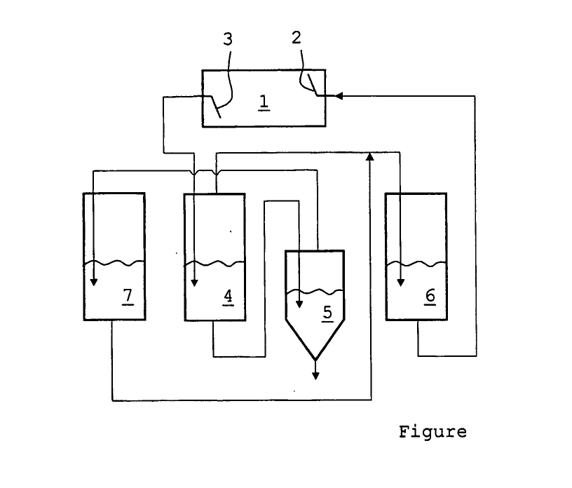

The present invention relates to a process for treating hides. More particularly, the present invention pertains to a process for degreasing and/or drying skins, hides, pelts, or leathers. The so-treated hides can be used in a conventional way, for example for making tanned leathers.

One of the most commonly used methods to degrease wet skins, besides methods using perchlorinated or trichlorinated solvents, is treating these skins with organic solvents and non-ionic and/or anionic detergents in a drum in an aqueous environment to emulsify fats.

DE-OS 25 22 902, for example, describes degreasing compositions containing non-Ionic and/or anionic surfactants as auxiliaries in alcohol-based solvents. WO 93/18188 describes the use of degreasing agents based on non-ionic emulsifiers of the fatty alcohol alkoxylate type for degreasing skins, hides, leathers, and the like. Said non-ionic emulsifiers contain a mixture of (a) C₁₂-C₁₈ fatty alcohol ethoxylates with an average of more than 6 EO groups in the molecule and (b) first-runnings fatty alcohol ethoxlates with more than 3 EO groups in the molecule, with (i) the fatty alcohols on which components (a) and (b) are based having an iodine number of under 10 and (ii) component (b) being present in a quantity of 2 to 10% by weight, in relation to the sum of (a) and (b). A major disadvantage of these processes, however, is that the generated waste water will contain tensides, fats, and salts which are difficult to biodegrade and/or recycle. Another disadvantage is that the result reached by this method is not as efficient as with methods using perchlorinated or trichlorinated solvents.

Another degreasing method for wet skins is to treat these skins with hydrocarbons, such as derivatives of petroleum, white spirit, and nonyl phenol. A disadvantage of these degreasing methods is that water does not dissolve in the solvents employed. Hence the skins have to be dried in a separate process step. Besides, with said degreasing methods highly polluted waste water is generated.

Dry skins, on the other hand, are generally degreased by using chlorinated solvents such as PER (tetrachloroethylene) and TRI (trichloroethylene). However, these solvents are known to be highly undesired in respect of human health as well as from an environmental point of view.

It is an object of the present invention to provide an efficient alternative to the current techniques used to eliminate natural fat contained in dry or wet skins, one which is less toxic and/or causes less environmental pollution while having the additional advantage that water contained in the skins will be extracted along with the fat.

Accordingly, the invention relates to a process for degreasing and/or drying skins comprising the steps of contacting the skins with at least one extractor solvent which is capable of dissolving both fats and water. Suitable extractor solvents include dimethyl ether (DME), methylal, dioxolane, diethyl ether, methyl ethyl ketone, alcohols such as ethanol, propanol, and isopropanol, and mixtures thereof. Because of the ease of their recovery and for safety reasons, preferably those solvents are used which are gaseous at atmospheric pressure at room temperature. Although this is less preferred, the above-mentioned solvents can also be used as a mixture with one or more fat-miscible solvents, such as esters, including methyl, ethyl or propyl acetate: hydrocarbons, including n-pentane, i-pentane, cyclopentane, hexane, cyclohexane, heptane, white spirit or petroleum ether; glycols, including 2-ethoxyethanol, or 2-butoxyethanol; or chlorinated hydrocarbons, including CHF₂CH₂CF₃, CF₃CHFCF₃, CF₃Br, or CF₃CH₂F. More preferably, a mixture of methylal and DME is used, However, most preferably dimethyl ether Ls used as the extractor solvent.

Dimethyl ether (DME) is gaseous under standard atmospheric conditions. It can be readily liquefied by cooling to below −25° C. at atmospheric pressure or by compression to above about 5 atmospheric pressure at room temperature. Liquefied dimethyl ether has the advantage that it readily dissolves most fats and also dissolves about 6.3% by weight of water at 20° C. It has a specific gravity of 0.661 and a latent heat of vaporisation of 96.6 cal/g.

The process according to the present invention can be used as an initial step to remove fat and/or water from fresh skins or from wet tanning or pretanning skins, but it can also be a degreasing step in a subsequent tanning process. Thus, the skins which can be used in the process according to the present invention can be any skin which is also suitable for conventional degreasing and/or drying processes. It is therefore noted that the term “skins” used throughout this document is meant to denominate fresh, wet, and dry skins, i.e. skins which are not salted or treated, obtained from animal flaying or from processes for transforming leather, fresh salted skins, dry skins, or semicured skins which have undergone a chemical or physical preservation treatment or some kind of tanning process; skins that are manufactured articles which should undergo a similar process tos the one called dry cleaning; and skins obtained from sheepskin tanneries which may degrease the skins prior to or after picking or after tanning. It is furthermore noted that the term “fresh skin” denotes a skin which is directly obtained from a slaughterhouse, whereas the term “wet skin” denotes a skin which has already gone through some of the processes for preparing tanned leathers, such as tanning, pickling curing, liming, unhairing, washing, shearing wool, depilation, scraping flesh, etc.

The skins to be degreased are preferably selected from the group consisting of sheepskins, cowskins, goatskins, and pigskins. The skins of sheep, goats, or pigs are degreased in a higher proportion than cowskins. The process is similar when dealing with fresh, dry, semi-elaborated or finished skins. The fact that there may be chemical products in the skins such as salt, acids, alkaline detergents, etc. normally does not adversely effect the degreasing and/or drying process with the above-mentioned exactor solvents and therefore these skins can be employed in the degreasing and/or drying process according to the present invention. Moreover, those skilled in the art will recognise that the process according to the invention is open to conventional variations necessary for a special situation in the tannery where the process is to be performed or for the treatment of special hides or skins which are to be degreased and/or dried.

The extraction process according to the present invention can be performed in any reactor or vessel conventionally used in degreasing processes of skins, pelts, hides, or leathers. In a preferred embodiment, said process is performed under pressure in a conventional reactor wherein the content is static and which contains proper systems to wet the skins. In the so-called static reactor, the skins can be left folded at the bottom of the reactor or in a basket which is then introduced to the reactor. However, some dirt originating from parts of the reactor which are inaccessible to any cleaning and from pipes might adhere to the skins. Moreover, some water and/or dirt might accumulate in the folds. Therefore, in a preferred embodiment of the present invention, the skins are placed in a vertical position in the static reactor while their surface is wetted from top to bottom with the one or more extractor solvents, or in another position where they can be completely wetted by the one or more extractor solvents.

In another preferred embodiment, said process is performed in a conventional rotatory reactor. The advantage of a rotatory reactor is that the interface between the content interaction of the skin and the extractor solvent will be improved by the spinning, swing or vibrating movement, thus reducing extraction times and activation the process.

The total amount of solvent used in the degreasing and/or drying process according to the present invention, the pressure applied, and the temperature in the reactor are chosen to be optimised on the total weight of the skins, their fat content to be removed, the analysed content of water contained in the skins, and possible previous treatments. For example, the optimum pressure to be applied is dependent on the manner of dosage of extractor solvent, and on the amount(s) and type(s) of extractor solvent(s) used. However, normally a pressure between 1 to 12 bar is applied, preferably of less than 10 bar, and most preferably of less than 8 bar.

In order to remove fat in a most effective way and to prevent other problems, the temperature must be controlled and preferably Is less than 50° C., more preferably less than 45° C., and most preferably less than 40° C. The temperature applied preferably is higher than 5° C., more preferably higher than 10° C., and most preferably higher than 15° C. This can be conveniently achieved by controlling the temperature of a recycle stream to the extractor machine or by heating or cooling the reactor. The high extractive effectiveness of the one or more extractor solvents allows working in a large range of temperatures, but preferably temperatures above room temperature are applied. Most preferably, the temperature is in the range of from 20° C. to 35° C. The temperature is preferably controlled within 5% of the set point in order to obtain a reproducible process.

Before introducing the one or more extractor solvents into the reactor and in order to ensure safety, preferably appropriate measures are taken, such as introducing an inert atmosphere in the reactor before the skins are contacted with the one or more extractor solvents. More preferably, the reactor remains under an inert atmosphere during most or all of the degreasing and/or drying process. In a preferred embodiment, CO₂ or N₂ or other inert or extinguisher gases are used for this purpose. Maintaining a constant pressure by means of the inert gas during the extraction process provides additional safety and it adds energy to the process.

During the degreasing and/or drying treatment the one or more extractor solvents, optionally in combination with a fat-miscible solvent which is not water-soluble, can be dosed continuously, meaning that for a certain period of time the combined solvents are continuously added to the reactor. Dosing of the extractor solvent(s) to the reactor can also be done intermittently during the operation, in which case the skilled person will be able to select the optimum interval times and optimum amounts of extractor solvent(s) to be dosed by routine experimentation. A combination of these techniques is also possible. Examples of a combination of such techniques include, for instance, a process wherein the exactor solvent(s) is/are first added continuously, then the addition is stopped, and then again it/they is/are added continuously. A continuous dosing operation, however, is most preferred. In a particularly preferred embodiment, the extractor solvent(s) is/are dosed while the extractor liquid comprising extractor solvent(s), water, and fat is removed from the reactor in an even more preferred embodiment, the extractor liquid thus isolated is purified.

If it is desired to retain a certain degree of humidity in the skins, a small amount of water can be added to the (recycled) extractor solvent(s). Thus, by varying the amount of water in the extractor solvent(s), the degree of drying can easily be regulated and a skin having the desired degree of humidity is obtained.

Once the skins are defatted and dried to the desired extent, the extractor liquid is removed from the reactor, preferably in a closed circuit. Said liquid will contain any residues of fat, proteins etc. Preferably, the extractor solvent(s) is/are isolated from the liquid, and most preferably recycled in the process. The obtained skins will contain a certain amount of extractor solvent(s) absorbed therein. This/these solvent(s) is/are eliminated using temperature and/or vacuum control, or by stripping with an inert gas. Preferably, the extractor solvent(s) is/are evaporated and recovered. Most preferably, the extractor solvent(s) is/are recycled. The process will be considered finished when there is an inappreciable quantity of the extractor solvent(s) absorbed in the skins, as determined by taking samples of the evaporated gases.

When DME is used as the extractor solvent or as one of the extractor solvents employed in the degreasing and/or drying process according to the present invention, the presence of water and its solubility in DME improve the safety of the process as regards flammability, because the minimum and maximum values of flammability are reduced. Thanks to its high diffusivity, DME penetrates the skin easily, solving the water and fat contained therein, under the formation of an extractor liquid which besides water and fats will basically contain proteins, etc. without polluting residues. These components can be isolated from the extractor liquid, thus recovering the DME. Preferably, the recovered DME is stored for subsequent processes and if necessary, it can be purified sufficiently to be used as a commercial product.

Preferably, the skins are contacted with the one or more extractor solvents for a fixed term. The desired extraction time depends on the fat and water contents in the skins, the difficulty of extracting them, and the desired result. Typically, the extraction time is less than 10 hours, more preferably less than 8 hours, even more preferably less than 4 hours, and most preferably less than 1 hour Preferably, the skins are contacted with the extractor solvent(s) for more than 10 minutes, more preferably more than 20 minutes, and most preferably more than 30 minutes. In a preferred embodiment, there is the possibility of taking samples of the extractor liquid during the extraction process to determine, by means of conventional techniques, the point at which the skins are sufficiently decreased and/or dried. Normally, when the type of skin to be treated is known, i.e, the breed of animal, as well as the region the animal came from, its feed, etc., the skilled person can easily find out the fat content contained in the skin. For example, it is known to the skilled person that the skin of Spanish merino sheep generally contains approximately 12% fat, while the skin of Australian and English sheep usually contains more than 30% fat. Furthermore, it is generally known that pigskins have a high fat content

With the process according to the present invention skins can be obtained which are practically dry and perfectly clean. The process according to the present invention allows the skins to be degreased to a percentage of preferably more than 60%, more preferably more than 75%, even more preferably more than 90%, and most preferably More than 98%, of the total amount of fat originally contained in the skins, The process according to the present invention allows the skins to be dried to a percentage of preferably more than 30%, more preferably more than 50%, even more preferably more than 75%, and most preferably more than 90%, of the total amount of water originally contained in the skins. For some purposes, however, it is preferred to maintain a certain humidity level in the skins (vide supra).

As discussed above, the required amount of extractor solvent(s) to achieve satisfactory percentages of degreasing and/or drying is dependent on the type(s) of extractor solvent(s) used, the fat and water contents in the skins to be treated, and the extent to which one wishes the skins to be degreased and/or dried. However, in general, the use of an amount of extractor solvent(s) of 40 litres per kg of skin to be degreased and/or dried, more preferably of 20 litres, and most preferably of less than 5 litres per kg of skin to be degreased and/or dried will suffice for obtaining a skin which is practically dry and perfectly clean. However, it is noted that the longer the extraction times, the less solvent is needed to achieve the desired results.

The present invention is elucidated by means of the following non-limiting Examples.

### EXPERIMENTAL

### Example 1

One fresh sheepskin and one fresh goatskin, obtained from a slaughterhouse, recently flayed, with the wool residue of the animal adhered, and dirty (not washed or treated) were left folded at the bottom of a metallic basket, which is the support for samples, in folds of 30×30 cm. The basket was then introduced to a static reactor with a content of 140 litres under a pressure of 4.1 bar. Subsequently, CO₂ gas was introduced into the reactor. The reactor was purged with dimethyl ether (DME) until the air and CO₂ gas were eliminated and a vacuum was created. The whole equipment was weighed, The equipment weighed 357 kg and the weight of the combined skins was calculated to be 2,240 g. Subsequently, 53 kg of DME was added in the liquid phase at a rate of 17 kg/in. The temperature was measured and the reactor was heated to 27° C. and kept at that temperature for a period time of 1 hour. During this hour, DME was recirculated to the top of the reactor by a pump with a flow rate of 17 kg/min. Some of this DME was recycled removing mainly water and fat Thus, the skins were repeatedly washed with DME. After 1 hour, the reactor was emptied of DME and brought under a CO₂ atmosphere, and the combined gases were pulled away to a venting area. Subsequently, the skins were weighed. In a first weighing the skins weighed 1,790 g, due to the presence of absorbed DME. After six hours the absorbed DME had evaporated, and the skins weighed 1,640 g. This means a total loss of weight of 640 g of water and fat, which is 28.6% of the weight of the untreated skins.

By analysing the internal fluid during the process, it was possible to calculate not only the quantity of dehydrated water, but also the fat removed. It turned out that the extractor flow contained approximately 1% fat per 70 g of DME. Since the skins contained approximately 12/14% fat, the extraction of fat was effective.

### Example 2

A wet sheepskin and a wet goatskin called “double face” (clean and without flesh, untanned) with the wool cut to measure, were left folded at the bottom of a metallic basket, which is the support for samples, in folds of 30×30 cm and subsequently introduced to a static reactor of 140 litres. The skins together weighed 2,180 g. A similar procedure to the one described for Example 1 was followed. However, the recycling was omitted. Instead, four washes with 15 kg of DME in the pumping circuit were carried out. Each time, the injected DME was pumped in at a rate of 17 kg/min. After sixty minutes the reactor was emptied of DME and the skin was weighed. In a first weighing the skins weighed 1,630 g, due to the presence of absorbed DME. After twelve hours the absorbed DME had evaporated, and the skins weighed 1,270 g. This means a total loss of weight of 910 g of water and fat, which is 41.7% of the weight of the untreated skins.

The dried and degreased skins obtained with the procedures according to Examples 1 or 2 were practically dry, but since some water was still present in the folds, Examples 3 and 4 were performed while the skins were hanging and while wetting their surfaces from top to bottom.

### Example 3

Two dry “double face” sheep- and goatskins were introduced (clean and without flesh, dried, untanned) with the wool out to measure, in a static reactor of 140 litres. They were left hanging in vertical position and supported by the edges of a metallic basket. There were no folds wherein dirt and/or water could accumulate. The skins together weighed 1,230 g. The same procedure as the one described for Example 2 was followed. Hence, four washes were carried out each with 15 kg of DME in the pumping circuit, replacing each time the DME present in the reactor. Again, the injected DME was pumped in at a rate of 17 kg/min. New quantifies of DME were introduced approximately every 15 minutes and samples of circulating DME were taken. After sixty minutes (time of pumping) the reactor was emptied of DME. Subsequently a vacuum was created for two hours and the skin was weighed. In a first weighing the skins weighed 1,030 g, due to the presence of absorbed DME. After two hours the absorbed DME had evaporated, and the skins weighed 1,040 g, because due to their hygroscopic properties the skins had absorbed some atmospheric moisture. This means a total loss of weight of 190 g of water and fat, which is 15.44% of the weight of the untreated skins. The skins were practically dry.

Analysis carried out on these skins via the Soxlet method in accordance with Standard IUC-4/ISO 4048 using methylene chloride showed that the treated goat- and sheepskins merely had a fat content below 1% and 2%, respectively.

A higher extractive effectiveness was observed in the dry skins than in the wet ones.

### Example 4

Two small pieces of wet cowskin, a pickled cowskin and a cow pelt (clean and without flesh, wet, unhaired, untanned) of 560 g and 700 g weight, respectively, were left hanging in a vertical position, near the bottom of the metallic basket because of their small size, and they were supported by the edges of the basket. Subsequently, the metallic basket was introduced to a static reactor of 140 litres. There were no folds where dirt and/or water could accumulate. The same procedure as the one described in Example 2 was followed. Hence, four washes were carded out each with 15 kg of DME in the pumping circuit, replacing each time the DME as if it was introduced from a possible recycling installation. Again, the injected DME was pumped in at a rate of 17 kg/min. New quantities of DME were introduced approximately every minute and samples of circulating DME were taken. After sixty minutes (time of pumping) it was emptied of DME. Subsequently a vacuum was created for ten minutes and the skin was weighed. In a first weighing the skins weighed 270 g and 340 g, respectively. After two hours the weights of both skins were still the same. This means a total loss of weight of 290 g and 360 g, respectively, of water and fat, which is 48.2% and 51.4%, respectively.

Analysis carried out on these skins via the Soxlet method in accordance with Standard IUA4/ISO 4048 using methylene chloride showed that the treated cowskins both had a fat content below 1%.

1. Process for degreasing and/or drying skins which comprises contacting the skins to be degreased and/or dried with one or more extractor solvents comprising at least one solvent selected from the group consisting of dimethyl ether (DME), methylal, dioxolane, diethyl ether, and methyl ethyl ketone.

2. A process according to claim 1 wherein the extractor solvent is dimethyl ether (DME) or a mixture of solvents comprising dimethyl ether (DME).

3. A process according to claim 2 wherein the mixture of solvents comprises at least 10 wt % of DME, based on the total amount of solvents.

4. A process according to claim 1 wherein the skins are selected from the group consisting of sheepskins, cowhides, goatskins, and pigskins.

5. A process according to claim 1 wherein the one or more extractor solvents are used in combination with one or more fat-miscible solvents selected from the group consisting of esters such as methyl acetate, ethyl acetate, and propyl acetate; hydrocarbons such as n-pentane, i-pentane, cyclopentane, hexane, cyclohexane, heptane, white spirit, and petroleum ether; glycols such as 2-ethoxyethanol and 2-butoxyethanol; and chlorinated hydrocarbons such as CHF₂CH₂CF₃, CF₃CHFCF₃, CF₃Br, and CF₃CH₂F.

6. A process according to claim 1 any one of the preceding claims which is carried out in a static or rotatory reactor.

7. A process according to claim 1 which is carried out under a pressure of between 1 and 12 bar and at a temperature between 5° C. and 40° C.

8. A process according to claim 1 wherein the skins are contacted with the one or more extractor solvents for a period of time of between 10 min and 10 hours.

9. A process according to claim 1 wherein the skins are degreased to a percentage of more than 50 wt %, based on the total amount of fat originally contained in the fresh skins and/or dried to a percentage of more than 30 wt %, based on the total amount of water originally contained in the fresh skins.

10. A process according to claim 1 comprising the steps of
placing the skins to be degreased and/or dried in a reactor,
bringing the reactor under an inert atmosphere, and
contacting said skins with one or more extractor solvents by measuring out said extractor solvents continuously, intermittently, or by means of combination thereof, to the reactor.

11. A process according to claim 1 wherein the one or more extractor solvents are isolated after having been in contact with the skins and subsequently recycled.

12. A process according to claim 11 comprising the steps of
removing extractor solvent(s) containing residues of fat and/or water from the reactor and transporting the solvent(s) to a first vessel,
heating the solvent(s) in the first vessel
transporting the vapour phase resulting from this heating to a second vessel,
condensing the vapour phase in the second vessel, and
feeding the thus recovered solvent(s) to the reactor.

13. A process according to claim 12 comprising the further steps of
removing the liquid phase from the first vessel and transporting it to a third vessel,
boiling or flashing off extractor solvent(s) contained in the liquid phase,
feeding the extractor solvent(s) to the second vessel, either directly or via a fourth vessel.

14. A process according to claim 1 wherein between 0.5 and 40 litres of extractor solvents are used per kg of skins.
